(19) United States
(12) Patent Application Publication
(10) Pub. No.: US 2003/0115158 A1
(43) Pub. Date: Jun. 19, 2003

(54) System and method for determining a warranty price

(76) Inventor: John D. Richardson, Brentwood, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/027,624

(22) Filed: Dec. 19, 2001

(51) Int. Cl. G06G 7/00; G06F 17/00; G06F 17/60

(52) U.S. Cl. 705/400

(57) ABSTRACT

A computer based system and method determines a price associated a warranty for equipment in a transaction. The system includes a database for storing a set of actuarial data and a controller coupled to the database. The system and method receive input from a user, responsively establish an identifier associated with the equipment, receive a first set of warranty characteristics and determine a baseline premium based on the identifier and the set of warranty characteristics. Additionally, the system and method establish a second set of warranty characteristics, determine at least one modifier as a function of the second set of warranty of characteristics, and modify the baseline premium as a function of the at least one modifier to determine the warranty price.

### TECHNICAL FIELD

The present invention relates generally to the sale and leasing of equipment, and more particularly, to a computer based system and method for determining a warranty price for a piece of equipment.

### BACKGROUND

The purchase or lease of equipment, such as construction or agricultural equipment, engines, etc., is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary.

In a typical sale or lease, one step includes a quoting process. The quoting process may involve a discussion with the customer, generally, including determining the equipment which the customer desires to lease or purchase and type and size of desired payment.

Another step may be the credit process. The credit process involves requesting and receiving the customer credit scoring from a credit bureau. The credit scoring are used to determine the type of financing available to the customer. Other factors, may also be used to determine the type of financing available, such as the customer's payment history on past purchases or leases.

In a typical transaction there are several parties involved. The customer or client is the party purchasing or leasing the equipment. The seller or dealer is the party providing the equipment to the customer. Additionally, the manufacturer or a company affiliated with the manufacturer may be involved. Most equipment includes a manufacturer or dealer warranty which has a fixed term. The dealer or manufacturer additionally may make available to the customer an extended warranty for a fee.

Typically such warranties are provided at a fixed fee without taking into account information pertaining to the transaction, e.g., customer information or equipment use information. Such “one size fits all” warranties are difficult to price since the actual cost of the warranty (to the dealer or manufacturer) is difficult to discern for particular types of equipment, geographical locations, and/or use of the equipment. Furthermore, some customers may pay an inordinate amount for the warranty based on their intended use, history, etc. . . .

The present invention is aimed at one or more of the problems discussed above.

### SUMMARY OF THE INVENTION

In one aspect of the present invention a computer based method for determining a price associated a warranty for equipment in a transaction is provided. The method includes the steps of establishing a first set of warranty characteristics, and determining a baseline premium based the set of warranty characteristics. The method further includes the steps of establishing a second set of warranty characteristics, determining at least one modifier as a function of the second set of warranty of characteristics, and, modifying the baseline premium as a function of the at least one modifier to determine the warranty price.

In another aspect of the present invention, a computer based system for determining a price associated a warranty for equipment in a transaction is provided. The system includes a database for storing a set of actuarial data and a controller coupled to the database. The controller is adapted to receive input from a user, responsively establish an identifier associated with the equipment, receive a first set of warranty characteristics and determine a baseline premium based on the identifier and the set of warranty characteristics. The controller is further adapted to establish a second set of warranty characteristics, determine at least one modifier as a function of the second set of warranty of characteristics, and modify the baseline premium as a function of the at least one modifier to determine the warranty price.

In still another aspect of the present invention, a computer program product for determining a price associated a warranty for equipment in a transaction is provided. The computer program product includes computer readable program code means for establishing an identifier associated with the equipment, computer readable program code means for establishing a first set of warranty characteristics, and computer readable program code means for determining a baseline premium based on the identifier and the set of warranty characteristics. The computer program product further includes computer readable program code means for establishing a second set of warranty characteristics, computer readable program code means for determining at least one modifier as a function of the second set of warranty of characteristics, and computer readable program code means for modifying the baseline premium as a function of the at least one modifier to determine the warranty price.

### BRIEF DESCRIPTION OF THE DRAWINGS

FIG. 1 is a flow diagram of a transaction process including a warranty process, according to an embodiment of the present invention;

FIG. 2 is a block diagram of a system for determining a warranty price, according to an embodiment of the present invention;

FIG. 3 is a block diagram of a computer program product for determining a warranty price, according to an embodiment of the present invention;

FIG. 4 is a flow diagram of a method for determining a warranty price, according to an embodiment of the present invention;

FIG. 5A is an illustration of a graphic user interface implemented in a spreadsheet file, according to an embodiment of the present invention;

FIG. 5B is a second illustration of the graphic user interface of FIG. 5A; and,

FIG. 5C is an illustration of another portion of the spreadsheet file of FIG. 5A.

### DETAILED DESCRIPTION

With reference to the drawings, and in operation, the present invention provides a computer based system 200 and a method 400 for determining a warranty price for purchase or lease transaction for equipment, such as agricultural or construction equipment, engines, or any equipment or item which may be leased.

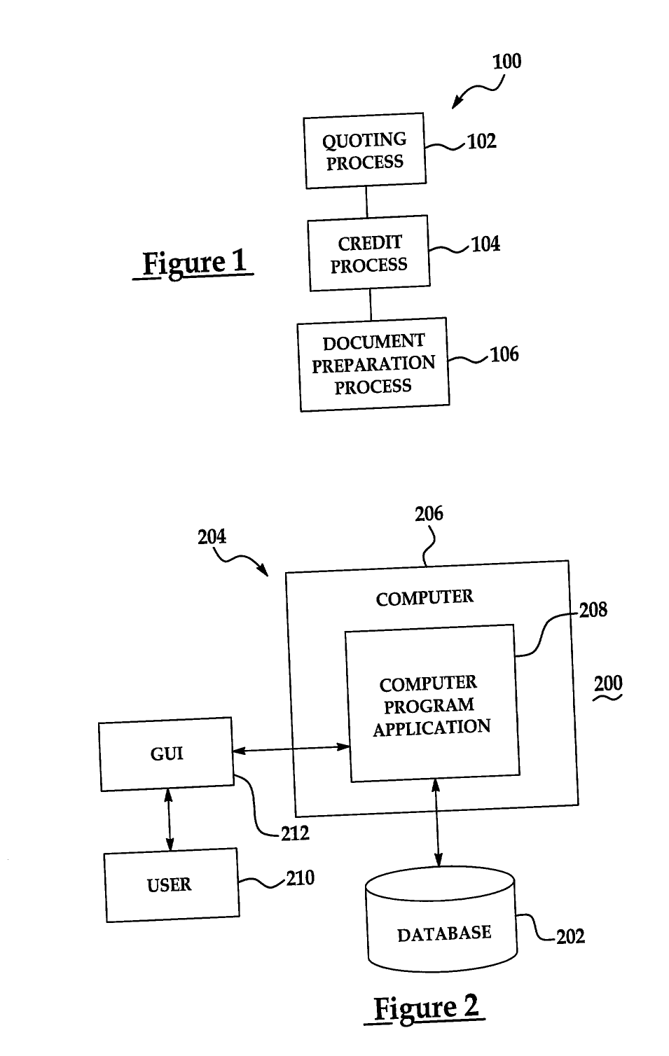

With specific reference to FIG. 1, the present invention may be utilized during the creation of a purchasing or leasing transaction 100 for equipment. e.g., the purchasing process. As described above, the creation process may include: a quoting process (flow block 102), a credit process (flow block 104), a document preparation process (flow block 106), and a tax determination process (flow block 108).

Generally, a customer desires to purchase or lease one or more pieces of equipment. The customer contacts a sales agent, who may be located at either a dealer of the equipment or at a financing company. Alternatively, the customer may interact with a user interface implemented on a computer network, e.g., a website on the internet.

In the quoting process 102, the agent works with the customer and determines the equipment which the customer wishes to purchase or lease (and the maximum monthly payment the customer desires).

During the quoting process 102, the customer may also be given the opportunity to purchase customer service plan and an extended warranty. Generally, the customer service plan includes scheduled or required maintenance (as defined in the agreement) for a period of years for a given fee. The extended warranty plan extends the basic warranty for a given period of time or event, e.g., one year or 10,000 hours, and a given fee (see below). It should also be noted that the customer service plan or extended warranty may be offered or purchased at any time, even after the sale or lease.

The present invention provides pricing for the extended warranty based on a number of parameters (see below). The system and method of the present invention may be adapted to establish the cost or price of the warranty to the customer. Alternatively or additionally, if the extended warranty is to be provided by a third party, such as the manufacturer, the present invention may be adapted to establish the cost or price of the warranty to the dealer or seller.

In the credit process 104, the sales agent requests a credit scoring for the customer from a credit bureau. This information, along with other information regarding the customer's history with the financing company, is used to determine whether to extend credit to the customer for the purchase or lease of the equipment and, if so, under what terms.

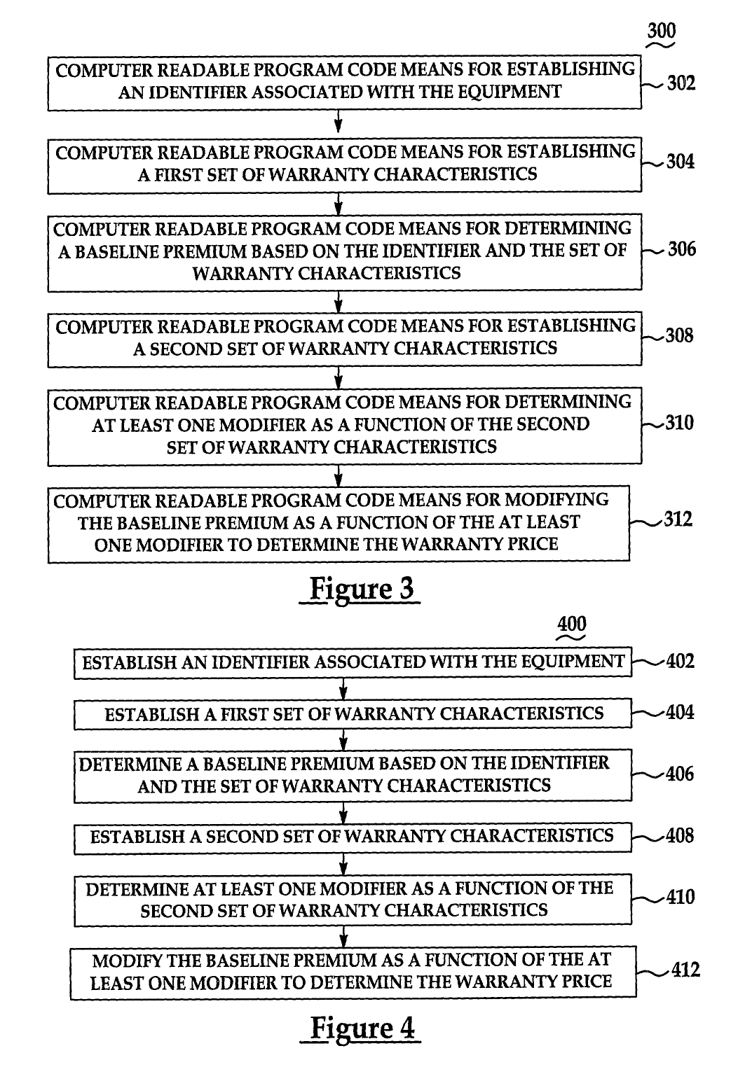

With specific reference to FIG. 2, the computer system 200 for determining the warranty price for equipment transactions, according to an embodiment of the present invention, will now be described.

The system 200 includes a database 202 for storing actuarial and related data and a controller 204 coupled to the database 202. The controller 204 is adapted to run a computer program application 208 in a conventional manner (see below). In one embodiment, the controller 204 is a stand alone computer 206 operable by a user 210 through a graphical user interface (GUI) 212.

In one aspect of the present invention the database 202 and the computer program application 208 are implemented within a spreadsheet file adapted to be opened/executed via a spreadsheet program, such as Microsoft Excel. The GUI 212 is implemented on a sheet of the spreadsheet file. The database 202 includes actuarial data which is based on actual data using known techniques. In one embodiment, the actuarial data is represented on various sheets within the spreadsheet file. It should be noted that the computer program application 208 may also be implemented using a database program, a standalone program or other suitable tool.

In another embodiment, the computer 206 is part of a computer network (not shown), such as the internet. The GUI 212 may be run on a second computer (not shown) connected to the network. The GUI 212 may be is implemented via a web enabled browser computer program, such as, Microsoft Internet Explorer.

In one embodiment, the controller 206 is adapted to receive input from the user 210, responsively establish an identifier associated with the equipment, e.g., a serial number, establishing a first set of warranty characteristics and determine a baseline premium based on the identifier and the first set of warranty characteristics. In one embodiment, the identifier and first set of warranty characteristics (and other inputs) are input by the 210. In another embodiment, the identifier and first set of warranty characteristics are established based on information received from other systems linked to the computer network.

The controller 206 is further adapted to establish a second set of warranty characteristics, determine at least one modifier as a function of the second set of warranty of characteristics, and modify the baseline premium as a function of the at least one modifier to determine the warranty price.

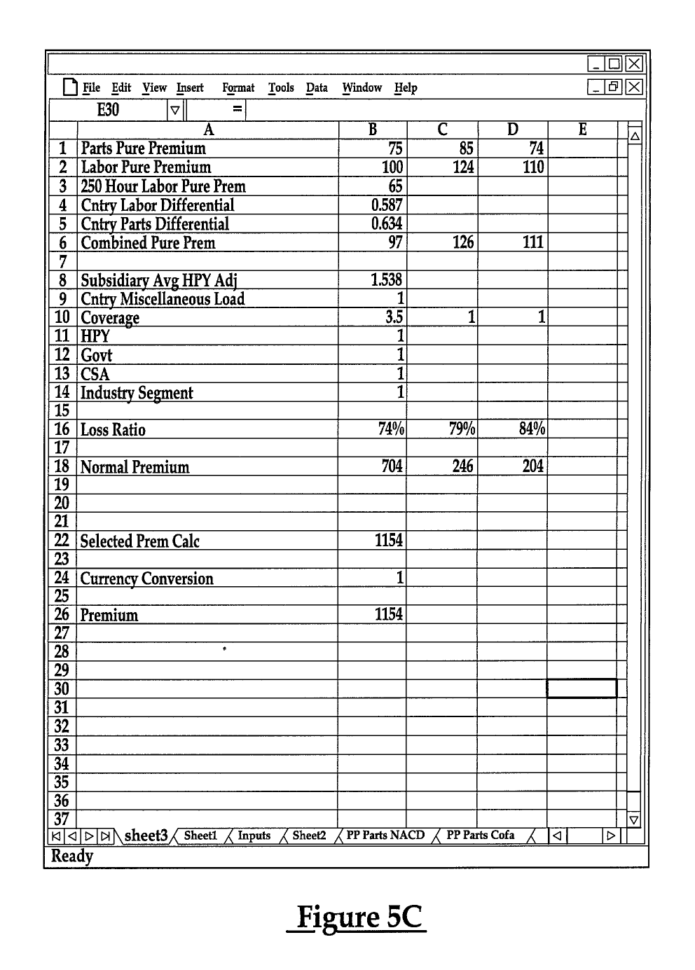

With reference to FIGS. 5A and 5B, in one embodiment the GUI 212 is implemented on an input sheet 502 within the spreadsheet file. The input sheet 502 includes a plurality of lists 504 from which the user 210 may select and/or enter information. Entries in one of the lists 504 may change the options in other lists 504. The GUI 212 illustrated in FIGS. 5A and 5B are related to construction and agricultural equipment. However, this is for exemplary purposes only. It should be noted that the present invention may be applied to determine warranty prices for other types of equipment, such as, automobiles, computer or electronic equipment, consumer goods, etc. . . . .

In the illustrated embodiment, the GUI 212 has the following lists 504:

a Dealer Code list 504A;

a Parts/Labor list 504B;

an Industry Segment list 504C;

a Customer Service Agreement (CSA) list 504D;

a Management Approval Required list 504E;

a Product Family list 504F;

a Model list 504G;

a Government (Govt) list 504H;

a Special list 5041;

a Country list 504J;

a Powertrain (Pwt) term list 504K;

a Powertrain and Hydraulics (P+H) Term list 504L;

a Total Term list 504M;

a Pwt Hours list 504N;

a P+H Hours list 5040; and

a Total Hours list 504P.

The Dealer list 504A

In one embodiment, the Parts/Labor list 404B allows the user 210 to select whether the warranty covers parts only, labor only or parts and labor.

In one embodiment, the controller 206 is adapted to receive a product family, provide a list of model numbers associated with the product family, and allow the user 212 to select the identifier from the list of model numbers. Other types of identifiers, which may be used instead of model numbers include a name of the equipment or some other parameter or name associated with a piece of equipment.

In the illustrated embodiment, a list of product families is displayed in the Product Family list 504F. Selection of a product family in the Product Family list 504F displays a list of the corresponding product model numbers in the Model list 504G. For example, selection of the “Backhoe Loaders” product family in the Product Family list 504F results in the following model numbers being displayed in the Model list 504G: 416, 420, 426, 428, 430, 432, 436, 438, 442, 446. As shown in FIG. 5B, selection of a different product family, such as “Excavators” results in a different list of model numbers being displayed in the Model list 504G. In the illustrated embodiment, a selected model number corresponds to the identifier of the equipment, e.g., “416” in FIG. 5A.

In one embodiment, the first set of warranty characteristics includes a geographic region. In the illustrated embodiment, the Country list 504J allows the user 212 to select the country in which the equipment is to be operated.

In one embodiment, the controller 206 is adapted to allow the user to select a term for the warranty. In the illustrated embodiment, the baseline premium is determined or modified as a function of the geographic region, the term, and the identifier. In the illustrated embodiment, each country corresponds to a geographic region, e.g., Asia, Europe, or North America. The spreadsheet file includes a sheet corresponding to each geographic region. Each sheet includes a plurality of premiums for each model of equipment in the corresponding geographic region. These premiums are based on actual repair/warranty data and derived using known methods. Additionally, there may be separate sheet for parts and labor (see below).

Furthermore, as explained below, the term selected by the user 212 may be divided into a plurality of sub-terms, typically years, for example first and second sub-terms. A baseline premium (e.g., first term premium and second term premium) may be determined using the sheet in the spreadsheet file for each subterm.

In one embodiment, the equipment includes first and second portions and the controller 204 is adapted to allow the user to select a term for the first portion and a term for the second portion. In general the first and second portions of the equipment are used where the equipment can be separated into two parts and where a separate warranty (term and parameters) is appropriate, e.g., the powertrain and tires of an automobile or the powertrain and hydraulics system of construction equipment.

In one embodiment, the user 210 may select a term expressed in a length of time from a purchase or lease date and a term expressed in number of hours of operation. Generally, the warranty is expressed only in terms of one or the other (length of time from the purchase or lease date or hours of operation). The controller 204, based on the user input information is adapted to determine which is more appropriate. For example, if a requested term defined by hours is greater than the average number of hours for the equipment at issue, this may signify that the customer intends to use the equipment more than the equipment is typically used. In this situation, it would be appropriate to define the warranty in terms of hours of operation. In one embodiment, the

In the illustrated embodiment, the equipment includes a powertrain and a hydraulics system. The GUI 212 allows the user 210 to enter a first desired term for the powertrain (Pwt Term), a first desired term for the powertrain and the hydraulics system (P+H Term) and a first desired term for the total or all of the equipment (Total Term). The first terms are expressed in a number of months and are selected using the Pwt Term list 504K, the P+H Term list 504L, and the Total Term list 504M, respectively. The GUI 212 also allows the user 210 to enter a second desired term for the powertrain, a second desired term for the powertrain and hydraulics system and a second desired term for the total or all of the equipment. The second terms are expressed in hours of operation and are selected using the Pwt Hours list 504N, the P_H Hours list 504O, and the Total Hours list 504P, respectively.

In the example shown in FIG. 5A, the user 210 has selected a Pwt term of 36 months, a P+H term of zero (0) months, and a total term of twelve (12) months. Additionally, the user 210 has selected 5000 hours for each of the powertrain hours, P+H hours and total hours. Since this is in line with the estimated usage of the equipment, the warranty is defined by a length of time from the purchase or lease date. In this example, the term is divided into a first year, a second year, and a third year.

Additionally, as shown in FIG. 5A, the user 210 has selected that both parts and labor are to be included in the warranty (see the Parts/Labor list 504B).

With reference to FIG. 5C, the spreadsheet file includes a sheet or a portion of a sheet which contains several calculations. In one embodiment, the controller 204 is adapted to determine a parts premium and a labor premium. As shown in the illustrated embodiment, a Parts Pure Premium (cells B1, C1, D1) and a Labor Pure Premium (cells B2, C2, D2) are determined for each sub-term (first year, second year, third year). These premiums are determined from data contained on other sheets within the spreadsheet file, as discussed above. In some countries, e.g., the United Kingdom, the first 250 hours of the operating life of the equipment is not covered by the standard warranty. Thus, a premium (in the illustrated example, 65).

In the illustrated embodiment, the parts and labor premiums contained in the spreadsheet are based on the region, e.g., Asia, Europe, North America. In each country within the region, there may be differences in the costs of parts and labor. In one embodiment, the controller 204 is adapted to determine a parts differential and a labor differential. In the illustrated embodiment, the parts differential and the labor differential are determined to be 0.587 and 0.634, respectively. A combined premium for each term is calculated as the sum of the Parts Pure Premium multiplied by the parts differential and the Labor Pure Premium multiplied by the labor differential, plus the 250 hour premium in the first term (see above). In the illustrated example, the combined pure premium or baseline premium for each term is 97, 126, and 110. The combined pure premiums are expressed in the currency of the country in which the equipment is to be operated, i.e., British pounds.

In one embodiment, the second set of warranty characteristics includes warranty coverage. The controller 204 is adapted to establishing a level of coverage of the equipment as a function of user input and to determine a coverage modifier as a function of the level of coverage. As stated above, the equipment includes a first portion and a second portion. The level of coverage is one of warranty for the first portion and warranty for the first and second portions. In the illustrated embodiment, there are three levels of coverage: coverage for the powertrain, coverage for the powertrain and the hydraulics system, and coverage for total equipment.

In the illustrated example, the parts and labor pure premium are based solely on the first portion or the powertrain of the equipment. Thus, if for a given sub-term, additional portions of the equipment are to be covered, the premium must be adjusted. As shown, in the first year, the total equipment is covered by the warranty. Based on data within the spreadsheet file and the information input by the user 210, a coverage modifier for the first year is determined (cell B10). In this embodiment, the coverage modifier for the first year is 3.5. The requested coverage for the second and third years is only for the powertrain. Thus, the coverage modifier in the second and third years is equal to 1. It should be noted that the parts and labor premium could be based on the second portion or the whole equipment, as appropriate.

In one embodiment, the second set of warranty characteristics includes the country of operation. The controller 204 is adapted to determine a country modifier as a function of the country of operation. As data is collected regarding warranty costs and repairs, the data may reflect other changes in the costs and repairs which are otherwise not accounted for in the data in the spreadsheet file. The country modifier is aimed at accounting for such differences. The country modifiers are located on a sheet within the spreadsheet which contains a list of country modifiers based at least on country and identifier. The country modifier is selected from the appropriate sheet and used in subsequent calculations. In the illustrated embodiment, the country modifier is placed in cell B1. It should be noted that in the illustrated embodiment, the country of operation is different than the geographic region. The geographic region includes parameters which may cut across country lines. The country of operation characteristics takes into account factors particular to a specific country.

In one embodiment, the second set of warranty characteristics includes an average number of hours of operation in the country of operation. The controller 204 is adapted to determine an average number of hours of operation modifier as a function of the country of operation and the identifier. For example, if the expected number of hours of operation of the equipment is different, either higher or lower, then the premium can be adjusted, either higher or lower. In the illustrated example, the average number of hours of operation modifier is equal to 1 (cell B11).

In one embodiment, the user 210 identifies whether or not the transaction is with a government (Government list 504H). The controller 204 is adapted to determine a government modifier if the transaction is with a government. In the illustrated example, the Government modifier is equal to 1 (cell B12).

In one embodiment, the user 210 identifies if the transaction includes a customer service agreement. The controller 204 is adapted to determine a customer service agreement modifier if the transaction includes a customer service agreement. For example, if a customer service agreement has been purchased, a discount of 5% or 10% may be given.

In one embodiment, the controller 204 is adapted to establish an industry segment in which the equipment is to be used and to determine an industry segment modifier as a function of the industry segment and the identifier. The user 210 selects the industry segment in which the equipment is to be used using the Industry Segment list 504C. If the industry segment in which the equipment is being used is different than its intended industry, then the extended warranty premium may be increased. For example, if an agricultural tractor where being used in building construction, the equipment may experience a harsher operating environment.

In one embodiment, the controller 204 determines a loss ratio. In the illustrated embodiment, the premium costs discussed above are the expected costs to the dealer or manufacturer based on the expected repair costs. The loss ratio takes into account, among other things, account overhead, investment income, and profit. The premium for the extended warranty may then be calculated as the sum of the following for each sub-term:

the combined pure premium (cells B6, C6, D6) multiplied by the modifiers (B8-B14, C10, D10). In the illustrated embodiment, the same modifier value is used for each sub-term except for the coverage modifier.

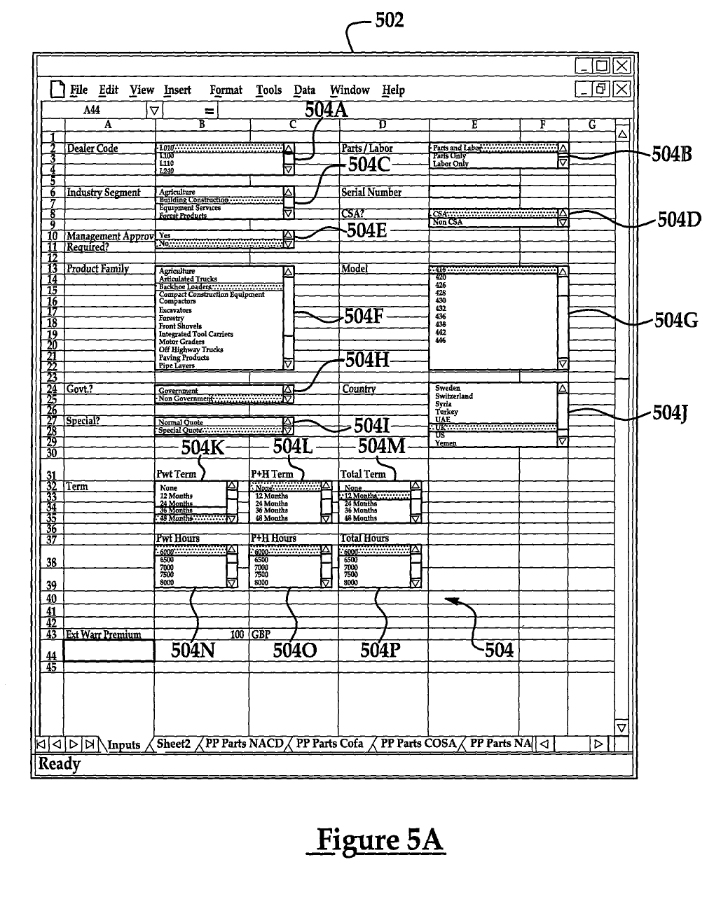

With reference to FIG. 3, a computer program product 300 for determining a price associated a warranty for equipment in a transaction is illustrated. The computer program product 300 includes computer readable program code means 302 for establishing an identifier associated with the equipment, computer readable program code means 304 for establishing a first set of warranty characteristics, and computer readable program code means 306 for determining a baseline premium based on the identifier and the set of warranty characteristics. The computer program product further includes computer readable program code means 308 for establishing a second set of warranty characteristics, computer readable program code means 310 for determining at least one modifier as a function of the second set of warranty of characteristics, and computer readable program code means 312 for modifying the baseline premium as a function of the at least one modifier to determine the warranty price.

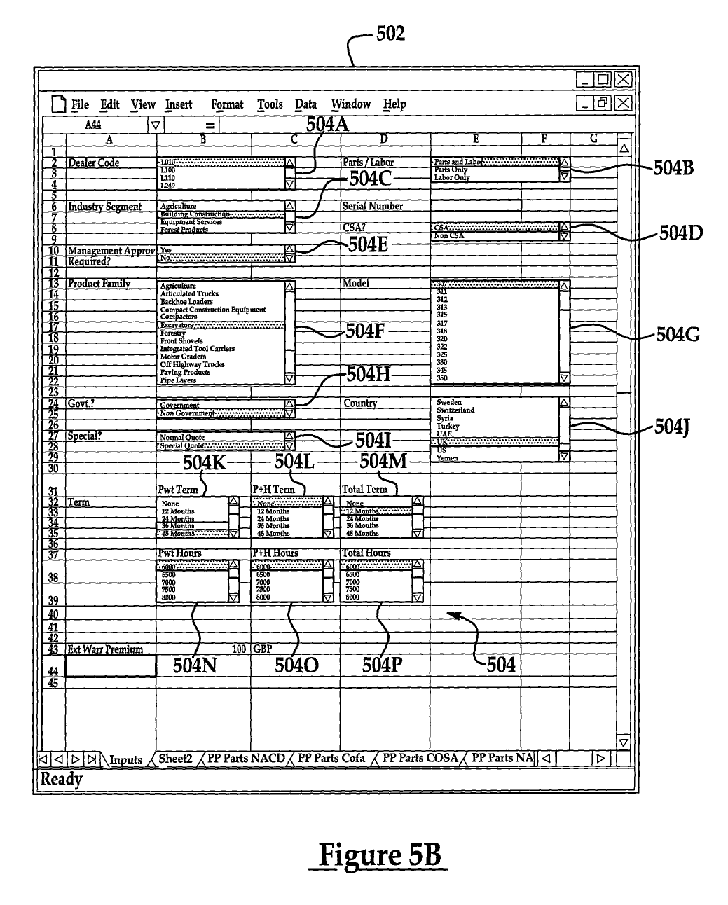

With reference to FIG. 4, a computer based method 400 for determining a price associated a warranty for equipment in a transaction, will now be discussed. In a first process block 402, an identifier associated with the equipment is established. In a second process block 404, a first set of warranty characteristics is established. In a third process block 406, a baseline premium based on the identifier and the set of warranty characteristics is determined. In a fourth process block 408, a second set of warranty characteristics is established. In a fifth process block 410, at least one modifier is determined as a function of the second set of warranty of characteristics. In sixth process block 412, the baseline premium is modified as a function of the at least one modifier to determine the warranty price.

Industrial Applicability

With specific reference to FIG. 1, the present invention provides a system and method 200, 400 for determining a price associated a warranty for equipment in a transaction. The system and method 200, 400, in practice, are generally part of a sale or lease transaction for, e.g., equipment. The customer (purchaser or lessee) interacts with an employee (sales agent) of a dealer, a financing company or the manufacturer. The customer may also interact with the present invention directly through a computer program application implemented on a computer or computer network, such as the internet.

As described above, there are generally three steps to the transaction: the quoting process, the credit process, and the document preparation process.

In the quoting process, the customer and the sales agent discuss the type and number of equipment, the type of contract, and the size payment the client desires. After these are determined, the agent performs a credit check on the customer to determine whether or not to extend the desired credit to the customer. Past customer conduct with respect to payment history to the financing company may also be considered. After the credit process, the transaction documents needs to be prepared.

During the quoting process or at any time (even after the sale or lease), an extended warranty may be offered to the customer. The present invention provides a method 400 and system 200 which allows a user to input data regarding the transaction, e.g., product family, model number, geographic region or country data, and data detailing the terms of the desired warranty. The method 400 and system 200 using actuary data compiled in a data file, e.g., sheets of a spreadsheet file, determines the cost of the extended warranty. In one embodiment, the extended warranty is provided through the manufacture or affiliated company. The cost of the extended warranty is the cost to the dealer. The dealer may add their own cost and/or profit before offering to the customer. Alternatively, the calculated cost may reflect the cost to the customer.

Other aspects and features of the present invention can be obtained from a study of the drawings, the disclosure, and the appended claims.

What is claimed is:

1. A computer based method for determining a price associated with a warranty for equipment in a transaction, including:
establishing an identifier associated with the equipment;
establishing a first set of warranty characteristics;
determining a baseline premium based on the identifier and the first set of warranty characteristics;
establishing a second set of warranty characteristics;
determining at least one modifier as a function of the second set of warranty of characteristics; and,
modifying the baseline premium as a function of the at least one modifier to determine the warranty price.

2. A computer based method, as set forth in claim 1, wherein the step of establishing an identifier associated with the equipment includes the steps of:
establishing a product family;
providing a list of model numbers associated with the product family; and,
selecting the identifier from the list of model numbers.

3. A computer based method, as set forth in claim 1, wherein the first set of warranty characteristics includes at least one of a term and a number of hours.

4. A computer based method, as set forth in claim 1, wherein the first set of warranty characteristics includes a geographic region.

5. A computer based method, as set forth in claim 1, including the step of selecting a term for the warranty.

6. A computer based method, as set forth in claim 5, wherein the term includes a number of years and the step of determining a base line premium includes the steps of:
determining a parts premium; and,
determining a labor premium.

7. A computer based method, as set forth in claim 6, wherein the step of determining a base line premium includes the step of determining a parts differential and a labor differential, wherein the base line premium is a function of the parts premium, the labor premium, the parts differential and the labor differential.

8. A computer based method, as set forth in claim 5, wherein the term has at least first and second sub-terms and the step of determining a baseline premium includes the step of determining a first term premium and a second term premium.

9. A computer based method, as set forth in claim 1, wherein the equipment includes first and second portions, the method including the step of selecting a term for the first portion and a term for the second portion.

10. A computer based method, as set forth in claim 1, wherein the equipment includes a powertrain and a hydraulics system and the method includes the steps of:
selecting a powertrain term for the powertrain; and,
selecting a hydraulics term for the hydraulics system.

11. A computer based method, as set forth in claim 10, wherein the powertrain term and the hydraulics term are defined by lengths of time since a purchase date.

12. A computer based method, as set forth in claim 10, wherein the powertrain term and the hydraulics term are defined by hours of operation.

13. A computer based method, as set forth in claim 10, including the step of selecting a total equipment term for the equipment.

14. A computer based method, as set forth in claim 10, wherein the total equipment term is defined by a length of time since a purchase date.

15. A computer based method, as set forth in claim 10, wherein the total equipment term is defined by hours of operation.

16. A computer based method, as set forth in claim 1, wherein the equipment includes a powertrain and a hydraulics system and the method includes the steps of:
selecting a first powertrain term and a second powertrain term, the first powertrain term defined by a length of time since a purchase date and the second powertrain term defined by hours of operation;
selecting a first hydraulics term and a second hydraulics term, the first hydraulics term defined by lengths of time since a purchase date and the second hydraulics term defined by hours of operation.

17. A computer based method, as set forth in claim 16, including the step of selection a first total equipment term and a second total equipment term, the first total equipment term defined by a length of time since a purchase date and the second total equipment term defined by hours of operation.

18. A computer based method, as set forth in claim 1, wherein the second set of warranty characteristics warranty coverage.

19. A computer based method, as set forth in claim 18, including the steps of:
establishing a level of coverage of the equipment; and,
determining a coverage modifier as a function of the level of coverage.

20. A computer based method, as set forth in claim 19, wherein the equipment includes a first portion and a second portion, the level of coverage is one of warranty for the first portion and warranty for the first and second portions.

21. A computer based method, as set forth in claim 19, wherein the equipment includes a first portion and a second portion, the level of coverage is one of warranty coverage for the first portion, warranty coverage for the first and second portion, and total warranty coverage for the equipment.

22. A computer based method, as set forth in claim 20, wherein the first portion is a powertrain and the second portion is a hydraulics system.

23. A computer based method, as set forth in claim 1, wherein the second set of warranty characteristics includes a country of operation.

24. A computer based method, as set forth in claim 23, including the step of determining a country modifier as a function of the country of operation.

25. A computer based method, as set forth in claim 1, including the step of establishing a country of operation and wherein the second set of warranty characteristics includes an average number of hours of operation in the country of operation.

26. A computer based method, as set forth in claim 25, including the step of determining an average number of hours of operation modifier as a function of the country of operation and the identifier.

27. A computer based method, as set forth in claim 1, including the step of determining a government modifier if the transaction is with a government.

28. A computer based method, as set forth in claim 1, including the step of determining a customer service agreement modifier if the transaction includes a customer service agreement.

29. A computer based method, as set forth in claim 1, including the steps of:
establishing an industry segment in which the equipment is to be used; and,
determining an industry segment modifier as a function of the industry segment and the identifier.

30. A computer based method determining a price associated with a warranty for equipment in a transaction, including:
establishing a product family;
providing a list of model numbers associated with the product family;
selecting an identifier from the list of model numbers;
establishing a first set of warranty characteristics, the first set of warranty characteristics including a term for the warranty;
determining a parts premium and a labor premium as a function of the term;
determining a baseline premium as a function of the identifier, the parts premium, and the labor premium;
establishing a second set of warranty characteristics;
determining at least one modifier as a function of the second set of warranty characteristics; and,
modifying the baseline premium as a function of the at least one modifier to determine the warranty price.

31. A computer based method determining a price associated with a warranty for equipment in a transaction, including:
establishing a product family;
providing a list of model numbers associated with the product family;
selecting an identifier from the list of model numbers;
establishing a first set of warranty characteristics, the first set of warranty characteristics including a term for the warranty;
determining a parts premium and a labor premium as a function of the term;
determining a baseline premium as a function of the identifier, the parts premium, and the labor premium;
establishing a level of coverage of the equipment, wherein the equipment as first and second portions and the level of coverage includes one of warranty for the first portion and warrant for the first and second portion;
determining a coverage modifier as a function of the level of coverage; and,
modifying the baseline premium as a function of the coverage modifier to determine the warranty price.

32. A computer based system for determining a price associated a warranty for equipment in a transaction, comprising:
a database for storing actuarial data;
a controller coupled to the database and being adapted to receive input from a user, responsively establish an identifier associated with the equipment, receive a first set of warranty characteristics and determine a baseline premium based on the identifier and the set of warranty characteristics and to establish a second set of warranty characteristics, determine at least one modifier as a function of the second set of warranty of characteristics, and modify the baseline premium as a function of the at least one modifier to determine the warranty price.

33. A computer based system, as set forth in claim 32, wherein controller is further adapted to receive a product family, provide a list of model numbers associated with the product family, and allow the user to select the identifier from the list of model numbers.

34. A computer based system, as set forth in claim 32, wherein the first set of warranty characteristics includes at least one of a term and a number of hours.

35. A computer based system, as set forth in claim 32, wherein the first set of warranty characteristics includes a geographic region.

36. A computer based system, as set forth in claim 32, wherein the controller is adapted to allow the user to select a term for the warranty.

37. A computer based system, as set forth in claim 36, wherein the term includes a number of years and the controller is adapted to determine a parts premium and a labor premium.

38. A computer based system, as set forth in claim 37, wherein the controller is adapted to determine a parts differential and a labor differential, wherein the base line premium is a function of the parts premium, the labor premium, the parts differential and the labor differential.

39. A computer based system, as set forth in claim 36, wherein the term has at least first and second sub-terms and the controller is adapted to determine a first term premium and a second term premium.

40. A computer based system, as set forth in claim 32, wherein the equipment includes first and second portions and the controller is adapted to allow the user to select a term for the first portion and a term for the second portion.

41. A computer based system, as set forth in claim 32, wherein the equipment includes a powertrain and a hydraulics system and the controller is adapted to allow the user to select a powertrain term for the powertrain and a hydraulics term for the hydraulics system.

42. A computer based system, as set forth in claim 41, wherein the powertrain term and the hydraulics term are defined by lengths of time since a purchase date.

43. A computer based system, as set forth in claim 41, wherein the powertrain term and the hydraulics term are defined by hours of operation.

44. A computer based system, as set forth in claim 41, wherein the controller is adapted to allow the user to select a total equipment term for the equipment.

45. A computer based system, as set forth in claim 41, wherein the total equipment term is defined by a length of time since a purchase date.

46. A computer based system, as set forth in claim 41, wherein the total equipment term is defined by hours of operation.

47. A computer based system, as set forth in claim 32, wherein the equipment includes a powertrain and a hydraulics system and the controller is adapted to allow the user to select first and second powertrain terms and first and second hydraulics terms, the first powertrain term defined by a length of time since a purchase date and the second powertrain term defined by hours of operation, the first hydraulics term defined by lengths of time since a purchase date and the second hydraulics term defined by hours of operation.

48. A computer based system, as set forth in claim 47, wherein the controller is adapted to allow the user to select a first total equipment term and a second total equipment term, the first total equipment term defined by a length of time since a purchase date and the second total equipment term defined by hours of operation.

49. A computer based system, as set forth in claim 32, wherein the second set of warranty characteristics includes a warranty coverage.

50. A computer based system, as set forth in claim 49, wherein the controller is adapted to establishing a level of coverage of the equipment as a function of user input and to determine a coverage modifier as a function of the level of coverage.

51. A computer based system, as set forth in claim 50, wherein the equipment includes a first portion and a second portion, the level of coverage is one of warranty for the first portion and warranty for the first and second portions.

52. A computer based system, as set forth in claim 50, wherein the equipment includes a first portion and a second portion, the level of coverage is one of warranty coverage for the first portion, warranty coverage for the first and second portion, and total warranty coverage for the equipment.

53. A computer based system, as set forth in claim 51, wherein the first portion is a powertrain and the second portion is a hydraulics system.

54. A computer based system, as set forth in claim 32, wherein the second set of warranty characteristics includes a country of operation.

55. A computer based system, as set forth in claim 32, wherein the controller is adapted to determine a country modifier as a function of a country of operation.

56. A computer based system, as set forth in claim 32, wherein the controller is adapted to allow the user to establish a country of operation and wherein the second set of warranty characteristics includes an average number of hours of operation in the country of operation.

57. A computer based system, as set forth in claim 56, wherein the controller is adapted to determine an average number of hours of operation modifier as a function of the country of operation and the identifier.

58. A computer based system, as set forth in claim 32, wherein the controller is adapted to determine a government modifier if the transaction is with a government.

59. A computer based system, as set forth in claim 32, wherein the controller is adapted to determine a customer service agreement modifier if the transaction includes a customer service agreement.

60. A computer based system, as set forth in claim 32, wherein the controller is adapted to establish an industry segment in which the equipment is to be used and to determine an industry segment modifier as a function of the industry segment and the identifier.

61. A computer based system for determining a price associated a warranty for equipment in a transaction, comprising:
a database for storing actuarial data; and,
a controller coupled to the database and being adapted to allow a user to establish a product family, provide a list of model numbers associated with the product family and allowing the user to select an identifier from the list of model numbers, to establish a first set of warranty characteristics, determine a parts premium and a labor premium as a function of the term, and determine a baseline premium as a function of the identifier, the parts premium, and the labor premium, the first set of warranty characteristics including a term for the warranty, and to establish a second set of warranty characteristics, determine at least one modifier as a function of the second set of warranty characteristics, and modify the baseline premium as a function of the at least one modifier to determine the warranty price.

62. A computer based system for determining a price associated a warranty for equipment in a transaction, comprising:
a database for storing actuarial data; and,
a controller coupled to the database and being adapted to allow a user to establish a product family, provide a list of model numbers associated with the product family, and select an identifier from the list of model numbers, to establish a first set of warranty characteristics, determine a parts premium and a labor premium as a function of the term, and determine a baseline premium as a function of the identifier, the parts premium, and the labor premium, the first set of warranty characteristics including a term for the warranty, to establish a level of coverage of the equipment and determine a coverage modifier as a function of the level of coverage, wherein the equipment as first and second portions and the level of coverage includes one of warranty for the first portion and warrant for the first and second portion, and to modify the baseline premium as a function of the coverage modifier to determine the warranty price.

63. A computer program product for determining a price associated a warranty for equipment in a transaction, including:
computer readable program code means for establishing an identifier associated with the equipment;
computer readable program code means for establishing a first set of warranty characteristics;
computer readable program code means for determining a baseline premium based on the identifier and the set of warranty characteristics;
computer readable program code means for establishing a second set of warranty characteristics;
computer readable program code means for determining at least one modifier as a function of the second set of warranty of characteristics; and,
computer readable program code means for modifying the baseline premium as a function of the at least one modifier to determine the warranty price.

64. A computer based method for determining a price associated with a warranty for a piece of equipment being sold or leased to a customer, comprising the steps of:
establishing a plurality of warranty characteristics, the plurality of warranty characteristics including a service repair history associated with the customer; and,
determining said warranty price in response to the plurality of warranty characteristics.

65. A computer based method, as set forth in claim 64, including the steps of:
determining a baseline premium as a function of the piece of equipment and at least a portion of the warranty characteristics;
determining a modifier in response to the service repair history associated with the customer; and,
modifying the baseline premium as a function of the modifier.

66. A computer based method, as set forth in claim 64, including the step of selecting a term for the warranty.

67. A computer based method, as set forth in claim 66, wherein the term includes a number of years and the step of determining a base line premium includes the steps of:
determining a parts premium; and,
determining a labor premium.

68. A computer based method, as set forth in claim 64, wherein the equipment includes first and second portions, the method including the step of selecting a term for the first portion and a term for the second portion.
